(19) United States
(12) Patent Application Publication
(10) Pub. No.: US 2026/0343154 A1
(43) Pub. Date: Oct. 29, 2026

(54) METHOD FOR CONTINUOUSLY ASSESSING A HEARING DEVICE SETTING

(71) Applicant: GN Hearing A/S, Ballerup (DK)

(72) Inventor: Jonas Raun HANSEN, Roskilde (DK)

(73) Assignee: GN Hearing A/S, Ballerup (DK)

(21) Appl. No.: 19/415,444

(22) Filed: Dec. 10, 2025

(30) Foreign Application Priority Data
Dec. 17, 2024 (EP) 24220430.3

(51) Int. Cl. H04R 25/00

(52) U.S. Cl. CPC H04R 25/305; H04R 25/505; H04R 25/604; H04R 2225/55

(57) ABSTRACT

A computer-implemented method for continuously assessing a hearing device setting used in a hearing device is disclosed. The hearing device comprises a housing, a control circuitry comprising a processing unit and a memory, a first and a second microphone, and a speaker. The method comprises capturing a first input signal using the first microphone, generating first sound processor audio data by processing the first input signal using a first sound processor, generating second sound processor audio data by processing the first input signal using a second sound processor, and determining whether the first sound processor audio data or the second sound processor audio data performs better based on a comparison of an objective measure.

### RELATED APPLICATION DATA

This application claims priority to, and the benefit of, European Patent Application No. 24220430 filed on Dec. 17, 2024. The entire disclosure of the above application is expressly incorporated by reference herein.

### FIELD

The present disclosure relates to audio data processing, sometimes referred to as audio signal processing. More specifically, the disclosure relates to a method for continuously assessing a hearing device setting, a method for determining a hearing device setting for a hearing device by using a connected device communicatively connected to the hearing device, the hearing device and an arrangement comprising the hearing device and the connected device.

### BACKGROUND

Many of the hearing devices of today offer noise cancelling in different forms and also other types of sound processing functionality, such as speech enhancement. Even though the performance has improved significantly over the last years, there is still room for improvement. An area of improvement is customization and how the hearing devices can be adjusted to meet the specific needs of various users.

### SUMMARY

It is an object to at least partly overcome one or more of the above-identified limitations of the prior art. In particular, it is an object to provide methods and devices that can be assessed and updated continuously without no or limited input required by the user.

By generating two sets of sound processor audio data based on the same input signal(s) from the microphone(s) of the hearing device, it is made possible to make a so-called silent assessment of an alternative hearing device setting, where different sound processors can be compared for performance without requiring the user to actively provide input. If a sound processor is performing better, the hearing device setting can be changed to comprise that sound processor, that is, a second sound processor being silently assessed may be used instead of the first sound processor used. As real world environments have a greater variety of sounds than the laboratory conditions in which many hearing device settings are developed, an advantage is that the performance of a sound processor can be evaluated more accurately. Further, by comparing the performance of the sound processors while the user is wearing them, the comparison may take into account the individual anatomy of the user.

Being able to continuously assess the second sound processor in parallel with normal operations of the hearing device may, under some circumstances, be particularly relevant for hearing devices equipped with two or more microphones used for enhancing and/or suppressing sounds from different directions under some circumstances. One reason for this is that the physical properties of the user affect the setting to a higher degree to, by way of example, a hearing device provided with only one microphone.

According to a first aspect, a computer-implemented method for continuously assessing a hearing device setting used in a hearing device is provided. The hearing device may comprise a housing, a control circuitry comprising a processing unit and a memory, a first microphone, and a speaker. The hearing device setting may comprise a first sound processor. The method may comprise capturing a first input signal using the first microphone, generating first sound processor audio data by processing the first input signal using the first sound processor, generating second sound processor audio data by processing the first input signal using a second sound processor, and determining whether the first sound processor audio data or the second sound processor audio data performs better based on a comparison of an objective measure.

The hearing device setting may comprise, e.g. performing feedback cancelation, beamforming, tinnitus reduction/masking, noise reduction, noise cancellation, speech recognition, bass adjustment, and/or treble adjustment.

The sound processor may convert an input signal to an output signal, wherein the input and output signals relate to sound.

The method may further comprise, in case the second sound processor audio data is determined to perform better than the first sound processor audio data based on the comparison of the objective measure, changing the hearing device setting to comprise the second sound processor, else, maintaining that the hearing device setting comprises the first sound processor.

The hearing device may further comprise a second microphone, and the method may further comprise capturing a second input signal using the second microphone; generating first sound processor audio data by processing the first and second input signals using the first sound processor; and generating second sound processor audio data by processing the first and second input signals using a second sound processor.

The first sound processor may comprise a first neural network, a first regression model, and/or a first digital signal filter, and the second sound processor may comprise a second neural network, a second regression model, and/or a second digital signal filter.

The step of determining whether the first sound processor audio data or the second sound processor audio data performs better based on the comparison of the objective measure may comprise the sub-steps of determining signal power for the first sound processor audio data, determining signal power for the second sound processor audio data, comparing the signal power for the second sound processor audio data with the signal power for the first sound processor audio data, and if the signal power for the second sound processor audio data is greater than the signal power for the first sound processor audio data, determine that the second sound processor audio data performs better than the first sound processor audio data.

The step of determining the signal power for the first sound processor audio data may comprise determining the signal power in frequency bands linked to speech. The step of determining the signal power for the second sound processor audio data may comprise determining the signal power in frequency bands linked to speech.

The method may further comprise that the objective measure is a speech intelligibility measure, and the step of determining whether the first sound processor audio data or the second sound processor audio data performs better based on the comparison of the objective measure comprises the sub-steps of determining a first speech intelligibility measurement for the first sound processor audio data, determining a second speech intelligibility measurement for the second sound processor audio data, comparing the first and second speech intelligibility measures for the second sound processor audio data with the signal power for the first sound processor audio data, and if the second speech intelligibility measurement is greater than the first speech intelligibility measurement, determine that the second sound processor audio data performs better than the first sound processor audio data.

A speech intelligibility measure may be, for example, Speech Transmission Index (STI), Common Intelligibility Scale (CIS), or Speech Intelligibility Index (SII).

An advantage is the sound processor may be evaluated for speech intelligibility in real world environments with speech patterns not replicable in a laboratory. Where the environment has changed to include increased speech, the hearing aid can better adapt to that environment.

The method may further comprise that the hearing device setting comprises a beamformer. Put differently, the first and/or second sound processor may comprise the beamformer. The beamformer is herein to be understood to be a signal processing technique used to enhance the reception or transmission of signals in a specific spatial direction while minimizing interference from other directions.

Being able to continuously assess the second sound processor in parallel with normal operations of the hearing device is particularly relevant for hearing devices equipped with two or more microphones used for enhancing and/or suppressing sounds from different directions.

The method may further comprise converting the first sound processor audio data into sound waves by using the speaker at a first time point, wherein the steps of generating second sound processor audio data by processing the first input signal using the second sound processor, and determining whether the first sound processor audio data or the second sound processor audio data performs better based on a comparison of an objective measure is performed at a second time point subsequent to the first time point.

The method may further comprise monitoring a utilization rate of the processing unit, in case the utilization rate is below a threshold, performing the steps of generating second sound processor audio data by processing the first input signal using the second sound processor, and determining whether the first sound processor audio data or the second sound processor audio data performs better based on a comparison of an objective measure.

The hearing device may further comprise a communication unit communicatively connected to a connected device, and said method may further comprise obtaining settings data pertaining to the second sound processor from the connected device, and transmitting comparison result data, pertaining to an outcome of the step of determining whether the first sound processor audio data or the second sound processor audio data performs better based on a comparison of an objective measure, to the connected device.

The hearing device may further comprise a communication unit communicatively connected to a connected device. The step of capturing the first input signal may be performed in the hearing device. The steps of generating the second sound processor audio data and determining whether the first sound processor audio data or the second audio data sound processor performs better based on a comparison of an objective measure may be performed in the connected device. The step of changing the hearing device setting to comprise the second sound processor may be performed in the hearing device.

The step of generating the first sound processor audio data by processing the first input signal using a first sound processor may be performed both in the hearing device and in the connected device.

Subsequent to the step of changing the hearing device setting to comprise the second sound processor, the method may further comprise identifying indirect user feedback data.

According to a second aspect it is provided a method for determining a hearing device setting for a hearing device by using a connected device communicatively connected to the hearing device. The method may comprise obtaining comparison result data pertaining to an outcome of a step of determining whether first sound processor audio data or previous second sound processor audio data performs better based on a comparison of an objective measure from the hearing device, wherein the previous second processor audio data is generated by processing a first input signal with a previous second sound processor, and the first sound processor audio data is generated by processing the first input signal with a first sound processor, wherein the first input signal is captured by a first microphone of the hearing device, applying a data processing model, wherein the data processing model receives as inputs information about the previous second sound processor, information about the first sound processor and the comparison result data, and outputs settings data pertaining to a second sound processor, and transmitting the settings data from the connected device to the hearing device.

The data processing model may be based on reference data originating from a plurality of different users.

According to a third aspect it is provided a hearing system comprising a hearing device comprising a housing, a control circuitry comprising a processing unit and a memory, a first microphone, a speaker, and a connected device communicatively connected to the hearing device, wherein the arrangement is configured to: capture a first input signal using the first microphone, generate first sound processor audio data by processing the first input signal, generate second processor audio data by processing the first input signal, and determine whether the first sound processor audio data or the second sound processor audio data performs better based on a comparison of an objective measure.

According to a fourth aspect it is provided hearing device comprising a housing, a control circuitry comprising a processing unit and a memory, a first microphone, and a speaker, wherein said control circuitry is configured to: capture a first input signal using the first microphone, generate first sound processor audio data by processing the first input signal using a first sound processor, generate second sound processor audio data by processing the first input signal using a second sound processor, and determine whether the first sound processor audio data or the second sound processor audio data performs better based on a comparison of an objective measure.

According to a fifth aspect it is provided a connected device comprising a control circuitry comprising a processing unit and a memory, wherein the connected device is communicatively connected to a hearing device, wherein the control circuitry is configured to: obtain comparison result data pertaining to an outcome of a step of determining whether first sound processor audio data or previous second sound processor audio data performs better based on a comparison of an objective measure from the hearing device, wherein the previous second processor audio data is generated by processing a first input signal with a previous second sound processor, and the first sound processor audio data is generated by processing the first input signal with a first sound processor, wherein the first input signal is captured by a first microphone of the hearing device, apply a data processing model, wherein the data processing model receives as inputs the previous second sound processor, the first sound processor and the comparison result data, and outputs settings data pertaining to a second sound processor, and transmit the settings data from the connected device to the hearing device.

According to a sixth aspect it is provided a computer program product, loadable in a memory of a control circuitry of a hearing device, comprising instructions suitable for performing the steps of the method according to the first aspect.

The hearing device can be a hearing aid, i.e. one or two devices configured for alleviating a hearing loss and worn by a user in one or two ears. As is commonly known, the hearing devices may be provided with one or several microphones, processors, and memories for processing the data received by the microphone(s), and one or several transducers provided for producing sound waves to the user of the hearing device. In case of having two hearing devices, these may be configured to communicate with each other such that the hearing experience could be improved. The hearing device may also be configured to communicate with a connected device, such as a mobile phone, and the audio input data may in such case be captured by the mobile phone and transferred to the hearing device. The mobile phone may also in itself constitute the hearing device.

The term ‘hearing device’ should not be understood in this context as a device solely used by persons with hearing disabilities, but instead as a device used by anyone interested in perceiving speech more clearly, i.e. improving speech intelligibility. The hearing device may, when not being used for providing the audio output data, be used for music listening or similar. Put differently, the hearing device may be earbuds, a headset or other similar pieces of equipment that are configured so that when receiving the audio input data this can be transformed into the audio output data as described herein.

The hearing device may be configured to be worn by a user. The hearing device may be arranged at the user's ear, on the user's ear, over the user's ear, in the user's ear, in the user's ear canal, behind the user's ear and/or in the user's concha, i.e., the hearing device is configured to be worn in, on, over and/or at the user's ear. The user may wear two hearing devices, one hearing device at each ear. The two hearing devices may be connected, such as wirelessly connected and/or connected by wires, thus forming a binaural hearing aid system.

The hearing device may be a hearable such as a headset, headphone, earphone, earbud, hearing aid, a personal sound amplification product (PSAP), an over-the-counter (OTC) hearing device, a hearing protection device, a one-size-fits-all hearing device, a custom hearing device or another head-wearable hearing device. Hearing devices can include both prescription devices and non-prescription devices.

The hearing device may be embodied in various housing styles or form factors. Some of these form factors are earbuds, on-the-ear headphones, or over-the-ear headphones. The person skilled in the art is well aware of different kinds of hearing devices and of different options for arranging the hearing device in, on, over and/or at the ear of the hearing device wearer. The hearing device (or pair of hearing devices) may be custom fitted, standard fitted, open fitted and/or occlusive fitted.

The hearing device may comprise one or more input transducers. The one or more input transducers may comprise one or more microphones. The one or more input transducers may comprise one or more vibration sensors configured for detecting bone vibration. The one or more input transducer(s) may be configured for converting an acoustic signal into a first electric input signal. The first electric input signal may be an analogue signal. The first electric input signal may be a digital signal. The one or more input transducer(s) may be coupled to one or more analogue-to-digital converter(s) configured for converting the analogue first input signal into a digital first input signal.

The hearing device may comprise one or more antenna(s) configured for wireless communication. The one or more antenna(s) may comprise an electric antenna. The electric antenna may be configured for wireless communication at a first frequency. The first frequency may be above 800 MHz, preferably a wavelength between 900 MHz and 6 GHz. The first frequency may be 902 MHz to 928 MHz. The first frequency may be 2.4 to 2.5 GHz. The first frequency may be 5.725 GHz to 5.875 GHz. The one or more antenna(s) may comprise a magnetic antenna. The magnetic antenna may comprise a magnetic core. The magnetic antenna may comprise a coil. The coil may be coiled around the magnetic core. The magnetic antenna may be configured for wireless communication at a second frequency. The second frequency may be below 100 MHz. The second frequency may be between 9 MHz and 15 MHz.

The hearing device may comprise one or more wireless communication unit(s). The one or more wireless communication unit(s) may comprise one or more wireless receiver(s), one or more wireless transmitter(s), one or more transmitter-receiver pair(s) and/or one or more transceiver(s). At least one of the one or more wireless communication unit(s) may be coupled to the one or more antenna(s). The wireless communication unit may be configured for converting a wireless signal received by at least one of the one or more antenna(s) into a second electric input signal. The hearing device may be configured for wired/wireless audio communication, e.g., enabling the user to listen to media, such as music or radio and/or enabling the user to perform phone calls.

The wireless signal may originate from one or more external source(s) and/or connected devices, such as spouse microphone device(s), wireless audio transmitter(s), smart computer(s) and/or distributed microphone array(s) associated with a wireless transmitter. The wireless input signal(s) may originate from another hearing device, e.g., as part of a binaural hearing system and/or from one or more accessory device(s), such as a smartphone and/or a smart watch.

The hearing device may include a processing unit. The processing unit may be configured for processing the first and/or second electric input signal(s). The processing unit may be a processor, an integrated circuit, an application, functional module, etc. The processing unit may be implemented in a signal-processing chip or a printed circuit board (PCB). The processing unit may be configured to provide a first electric output signal based on the processing of the first and/or second electric input signal(s). The processing unit may be configured to provide a second electric output signal. The second electric output signal may be based on the processing of the first and/or second electric input signal(s).

The hearing device may comprise an output transducer. The output transducer, herein also referred to as electroacoustic transducer or receiver, may be coupled to the processing unit. The output transducer may be a loudspeaker. The output transducer may be configured for converting the first electric output signal into an acoustic output signal, comprising sound waves. The output transducer may be coupled to the processing unit via the magnetic antenna.

In an embodiment, the wireless communication unit may be configured for converting the second electric output signal into a wireless output signal. The wireless output signal may comprise synchronization data. The wireless communication unit may be configured for transmitting the wireless output signal via at least one of the one or more antennas.

The hearing device may comprise a digital-to-analogue converter configured to convert the first electric output signal, the second electric output signal and/or the wireless output signal into an analogue signal.

The hearing device may comprise a vent. A vent is a physical passageway such as a canal or tube primarily placed to offer pressure equalization across a housing placed in the ear such as an ITE hearing device, an ITE unit of a BTE hearing device, a CIC hearing device, a RIE hearing device, a RIC hearing device, a MaRIE hearing device or a dome tip/earmold. The vent may be a pressure vent with a small cross section area, which is preferably acoustically sealed. The vent may be an acoustic vent configured for occlusion cancellation. The vent may be an active vent enabling opening or closing of the vent during use of the hearing device. The active vent may comprise a valve.

The hearing device may comprise a power source. The power source may comprise a battery providing a first voltage. The battery may be a rechargeable battery. The battery may be a replaceable battery. The power source may comprise a power management unit. The power management unit may be configured to convert the first voltage into a second voltage. The power source may comprise a charging coil. The charging coil may be provided by the magnetic antenna.

The hearing device may comprise a memory, including volatile and non-volatile forms of memory.

The hearing device may comprise one or more antennas for radio frequency communication. The one or more antennae may be configured for operation in ISM frequency band. One of the one or more antennas may be an electric antenna. One or the one or more antennas may be a magnetic induction coil antenna. Magnetic induction, or near-field magnetic induction (NFMI), typically provides communication, including transmission of voice, audio, and data, in a range of frequencies between 2 MHz and 15 MHz. At these frequencies the electromagnetic radiation propagates through and around the human head and body without significant losses in the tissue.

The magnetic induction coil may be configured to operate at a frequency below 100 MHz, such as at below 30 MHz, such as below 15 MHz, during use. The magnetic induction coil may be configured to operate at a frequency range between 1 MHz and 100 MHz, such as between 1 MHz and 15 MHz, such as between 1 MHz and 30 MHz, such as between 5 MHz and 30 MHz, such as between 5 MHz and 15 MHz, such as between 10 MHz and 11 MHz, such as between 10.2 MHz and 11 MHz. The frequency may further include a range from 2 MHz to 30 MHz, such as from 2 MHz to 10 MHz, such as from 2 MHz to 10 MHz, such as from 5 MHz to 10 MHz, such as from 5 MHz to 7 MHz.

The electric antenna may be configured for operation at a frequency of at least 400 MHz, such as of at least 800 MHz, such as of at least 1 GHz, such as at a frequency between 1.5 GHz and 6 GHz, such as at a frequency between 1.5 GHz and 3 GHz such as at a frequency of 2.4 GHz. The antenna may be optimized for operation at a frequency of between 400 MHz and 6 GHz, such as between 400 MHz and 1 GHz, between 800 MHz and 1 GHz, between 800 MHz and 6 GHz, between 800 MHz and 3 GHz, etc. Thus, the electric antenna may be configured for operation in ISM frequency band. The electric antenna may be any antenna capable of operating at these frequencies, and the electric antenna may be a resonant antenna, such as monopole antenna, such as a dipole antenna, etc. The resonant antenna may have a length of λ/4±10% or any multiple thereof, A being the wavelength corresponding to the emitted electromagnetic field.

The present disclosure relates to different aspects including the hearing device and the system described above and in the following, and corresponding device parts, each yielding one or more of the benefits and advantages described in connection with the first mentioned aspect, and each having one or more embodiments corresponding to the embodiments described in connection with the first mentioned aspect and/or disclosed in the appended claims.

### BRIEF DESCRIPTION OF DRAWINGS

The above and other features and advantages will become readily apparent to those skilled in the art by the following detailed description of exemplary embodiments thereof with reference to the attached drawings, in which:

FIG. 1 illustrates a hearing device placed in an ear of a user.

FIG. 2 generally illustrates how a first sound processor can be compared with a second sound processor, and if the second sound processor performs better, replace the second sound processor with the first sound processor.

FIG. 3 is a flowchart illustrating a method for continuously assessing hearing device setting.

FIG. 4 is a flowchart more in detail illustrating the step of determining whether the first or second sound processor data performs better.

FIG. 5 is a flowchart illustrating how some steps of assessing the hearing device setting can be performed in a hearing device and other steps in a connected device.

FIG. 6 is another example of how some steps can be performed in the hearing device and other steps in the connected device.

FIG. 7 is yet another example of how some steps can be performed in the hearing device and other steps in the connected device.

FIG. 8 generally illustrates the hearing device and the connected device.

### DETAILED DESCRIPTION

Various embodiments are described hereinafter with reference to the figures. Like reference numerals refer to like elements throughout. Like elements will, thus, not be described in detail with respect to the description of each figure. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

Some hearing aids and other hearing devices are equipped with one or more microphones for reducing the effects of unwanted sounds. By having one microphone on the hearing aid, it is made possible to detect background noise and to compensate for this by adapting the sound waves generated by the hearing aid such that the background noise can eliminated by using destructive interference. Sometimes this type of functionality is referred to as active noise cancelling.

Having two microphones comes with the effect that the direction from which the background sounds is arriving can be detected. The general principle is that by having the two microphones spaced apart, there will be a time difference between the time of arrival of the background sound in the two different microphones. By way of example, in this way it is made possible to efficiently reduce the effect of a humming sound from an air conditioner placed on a left side of a user and at the same time amplify, or in other way enhance, the sound from a person speaking to the user placed on a right side of the user. Sometimes, two or more microphones used for this purpose are referred to as a directional microphone system.

A less advanced directional microphone system may be arranged such that there are fixed directions linked to suppression and enhancement. For instance, such system may be arranged such that sound arriving from a source identified to be in front of the user is speech enhanced, e.g. frequencies related to human speech are amplified, while sounds produced by another source placed next to or behind the user is assumed to be unwanted, that is, to be considered to be noise, and as an effect this is suppressed. The benefit of this approach is that an intuitive hearing aid can be achieved. By simply looking at the person speaking, the user may indicate in which direction he or she has an interest in hearing speech. This may be advantageous in some cases and preferred by some users, but in some sound environments this approach may not be suitable.

More advanced directional microphone system may have different settings for different environments, and some hearing aids using such systems may be able to automatically detect the environment. For instance, if the user is in a noisy restaurant speaking to a few persons at the same table, the system may detect the environment and adapt the settings automatically such that sounds from sources placed behind and next to the user is suppressed. On the other hand, if the user is in a conference room with a number of persons placed around a table with few or no other sounds than the speech of the persons around the table, the hearing aid may detect that the user is in an environment in which speech should be enhanced irrespective from which direction this arrives to the hearing aid.

Since different users are exposed to different sound environments, there is a risk with using pre-set sound environments with pre-set settings for direction-based suppression and enhancement. By way of example, some users may be exposed to sound environment being a combination of the pre-set sound environments, and some users may be exposed to sound environments that are very specific and not similar to any of the pre-set environments. Still a challenge with providing for those adaptive directional microphones-based hearing aids is that different users have different physical properties and wears the hearing aid in different ways. By way of example, the ear channel of one person may be different to another person's ear channel with the effect that what may work for one person may not work for the other due to different physical properties. One way to take into account the different physical properties of different persons is to have an audiologist to perform a so-called hearing aid fitting in which the hearing aid is customized to the person. This may involve both hardware as well as software adjustments.

As described above, the hearing aids having the functionalities described above are able to deliver first class hearing experiences, e.g. by using adaptive directional microphone systems making it possible to adapt how different sounds linked to different sources are treated based on the sound environment the user is currently exposed to. Even though significant progress has been made over the last couple of years, there is still room for improvement. One way to even further improving the hearing experience is to increase the customization and taking into account the user's unique physical properties and the sound environments linked to the user.

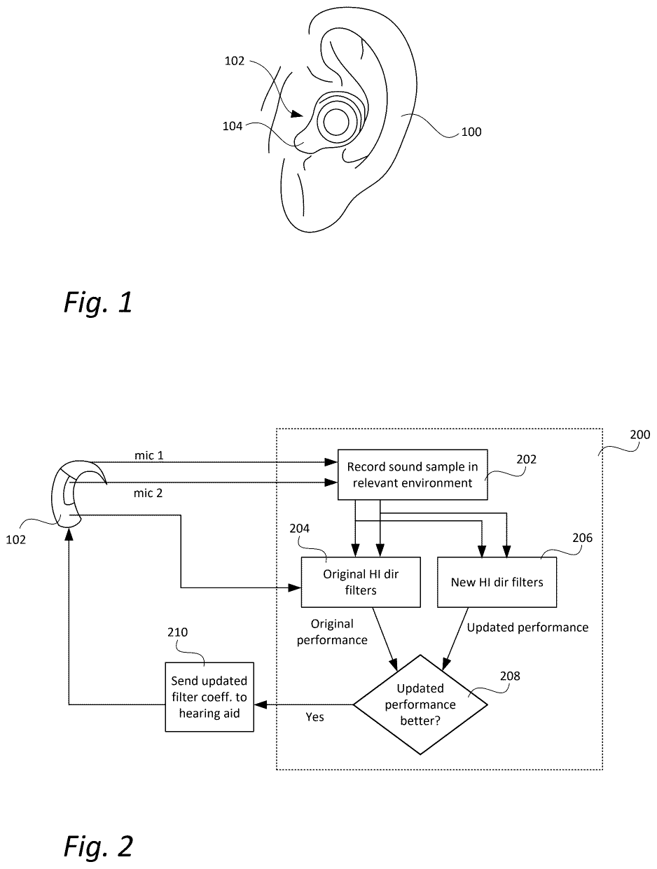

FIG. 1 illustrates a hearing device 102 placed in an ear 100 of a user. The hearing device 102 illustrated is a so-called in-the ear (ITE) hearing aid, which is a common form of hearing device, or more particularly hearing aid, used today. In this type of hearing device, a housing 104 of the hearing device 102 is placed in the ear 100. Other forms of hearing devices include behind-the-ear (BTE) devices, receiver-in-canal (RIC) or receiver-in-the-ear (RITE) devices, in-the-canal (ITC) devices, completely-in-canal (CIC) devices, invisible-in-canal (IIC) devices, bone-anchored hearing systems (BAHS), cochlear implants, and body-worn hearing aids. The hearing device may be placed in or around the ear of the user. Further, the terms “hearing device”, “hearing instrument” and “hearing aid” are used interchangeably in this document.

In an embodiment, a hearing device may have a single microphone, wherein the first and second sound processor process only a first input signal from the first microphone. In some of the examples below, even if described that two input signals-a first and a second input signal-from the first and second microphone, respectively, are used, it is equally possible to only use one input signal-the first input signal.

FIG. 2 generally illustrates by way of example how the first sound processor can be compared with the second sound processor, and if the second sound processor performs better, replace the second sound processor with the first sound processor. As illustrated, the hearing device 102, herein exemplified by a BTE hearing device, may be provided with a first and a second microphone generating a first and a second input signal, respectively. These signals can be transferred from the hearing device 102 to a connected device 200, e.g. a mobile phone communicatively connected to the hearing device 102. Based on these signals, a sound sample may be generated for a relevant environment, e.g. the environment detected by the hearing device 102. The sample may be processed using both a first sound processor and a second sound processor, and the first sound processor is referred to as original hearing instrument (HI) directional filters 204, and the second sound processor is referred to as new HI directional filters 206. By processing the sound sample using both directional filter settings, two different audio data sets are provided, herein referred to as 205 original performance comprising an evaluation of the first sound processor audio data and 207 updated performance comprising an evaluation of the second sound processor audio data. The two audio data sets may be compared to understand which of the two that performs better. This comparison can be based on an objective measure, such as measured power in speech frequency bands. In case the new HI directional filters perform better, these may be transmitted from the connected device 200 to the hearing device 102 such that the settings can be updated 210.

As described above, the hearing device may detect the environment and by knowing the environment, e.g. noisy restaurant environment, the settings may be updated for this specific environment. Since each environment may have its own settings, the concept of in situ optimization of directional filters based on off-line comparisons, described above, may be of particular relevance in hearing devices configured with specific settings for a plurality of different environments.

Even though illustrated in FIG. 2 that the first and second input signals are transmitted to the connected device 200, and having the updated filter coefficients being transmitted from the connected device to the hearing device, it is equally possible to have all steps performed within the hearing device. Further, as will be further discussed below, it is also possible to have some steps performed in the hearing device and other steps performed in the connected device. In addition, a split between the connected device and the hearing device may vary over time. For instance, in case there is spare data processing capacity in the hearing device, the assessment of the second sound processor may be made in the hearing device, while on the other hand, if there is no spare capacity, e.g. due to that the environment the user is currently exposed to requires substantial signal processing to deliver an adequate hearing experience, the steps may be performed in the connected device.

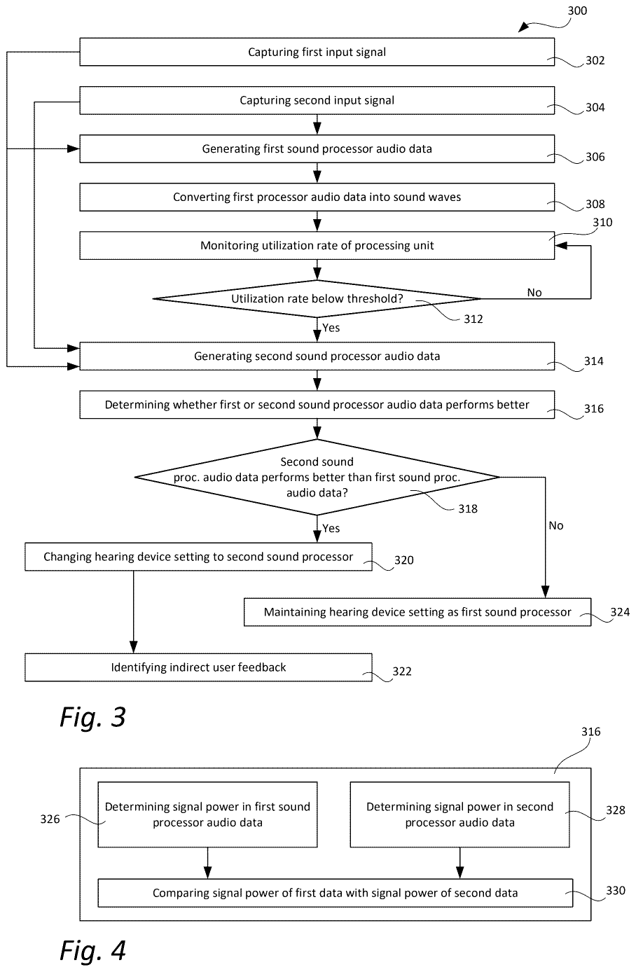

FIG. 3 is a flowchart by way of example illustrating a method 300 for continuously assessing a hearing device setting used in the hearing device 102. As illustrated, the method comprises capturing 302 the first input signal using the first microphone, and capturing 304 the second input signal using the second microphone. Further, the method may comprise generating 306 first sound processor audio data by processing the first and second input signals using a first sound processor, wherein the first sound processor is using the current hearing device setting, and generating 314 second sound processor audio data by processing the first and second input signals using a second sound processor. As illustrated in FIG. 1, the hearing device setting comprising the first sound processor may comprise original HI direction filter coefficients, and the second sound processor may comprise new HI directional filter coefficients. Instead of being different directional filter coefficients, the different settings may comprise different neural networks being configured and trained in different ways. Once having generated the first and second sound processor audio data, the method may comprise determining 316 whether the first sound processor audio data or the second sound processor audio data performs better based on a comparison of an objective measure.

If the second sound processor audio data performs better, this may result in that the hearing device setting is changed to comprise the second sound processor. Before such update is made, the user may be asked to confirm that he or she accepts, but in case the user prefers to have the current hearing device setting updated automatically, this is possible. The update may be made based on one sample only, or the current hearing device setting may be updated after a plurality of sound samples have been assessed with the same or similar results.

As illustrated in FIG. 3, in case the second sound processor audio data is determined to perform better than the first sound processor audio data based on the comparison of the objective measure, the method 300 may comprise changing 320 the hearing device setting to comprise the second sound processor else, maintaining 324 that the hearing device setting comprises the first sound processor.

The first and sound processor may both be a hardware component on their own, but each of these may also be a software-based module forming part of a common hardware component. In line with the description above, the first and second sound processor may also be embodied in different ways at different time points. For instance, if there is a spare processing capacity in a processing unit in the hearing device, both the first and second sound processor may form part of this unit, but in case a utilization rate of the processing unit is above a threshold, that is, no spare capacity for assessing the second sound processor, the first sound processor may form part of the processing unit in the hearing device, while the second sound processor can be formed in a processing unit of the connected device.

The first and second sound processor may each comprise a neural network, a regression model, and/or a digital signal filter. Put differently, the first and second sound processor may be a data processing model that can process incoming audio data such that, by way of example, speech is enhanced and non-speech sounds are suppressed. In case the first and second sound processors each comprise a neural network, the hearing device setting may comprise a neural network of the second sound processor trained with a different data set than the neural network of the first sound processor. Further, in some cases, the first and second sound processor may be of different types, e.g. the first sound processor is a neural network, and the second sound processor is a digital signal filter.

The objective measure may relate to speech intelligibility. As illustrated in FIG. 4, the step of determining 316 whether the first sound processor audio data or the second audio data sound processor performs better based on the comparison of the objective measure may comprise the sub-steps of determining 326 signal power for the first sound processor audio data, determining 328 signal power for the second sound processor audio data, comparing 330 the signal power for the second sound processor audio data with the signal power for the first sound processor audio data, and if the signal power for the second sound processor audio data is greater than the signal power for the first sound processor audio data, determine that the second sound processor audio data performs better than the first sound processor audio data. The step of determining 326 the signal power for the first sound processor audio data may comprise determining the signal power in frequency bands linked to speech, and wherein the step of determining 328 the signal power for the second sound processor audio data comprises determining the signal power in frequency bands linked to speech.

The method may further comprise converting 308 the first sound processor audio data into sound waves by using the speaker at a first time point. The steps of generating 314 second sound processor audio data by processing the first and second input signals using the second sound processor, and determining 316 whether the first sound processor audio data or the second sound processor audio data performs better based on a comparison 318 of an objective measure can be performed at a second time point subsequent to the first time point. By allowing for that the assessment of the second sound processor can be made at a later point of time, it is made possible to make such assessment when there is less need for data processing capacity. For instance, while someone is speaking to the user, the processing unit of the hearing device may utilize the data processing capacity to process the first and second input signals from the microphones into the first sound processor audio data, and also to convert this audio data into the sound waves. Once there is a pause in the discussion, that is, no speech is detected, the second sound processor audio data may be generated, and the first and second sound processor audio data may be compared.

The method may also comprise monitoring 310 a utilization rate of the processing unit of hearing device, in case the utilization rate is below a threshold 312, performing the steps of generating 314 second sound processor audio data by processing the first and second input signals using the second sound processor 822, and determining 316 whether the first sound processor audio data or the second sound processor audio data performs better based on the comparison of the objective measure.

Subsequent to the step of changing 320 the hearing device setting to comprise the second sound processor, the method may comprise identifying 322 indirect user feedback data, such as removal of the hearing device. By retrieving this indirect feedback and also, by way of example, providing this as input to the training of the neural network of the second sound processor, it is made possible to iteratively find customized settings of the hearing device with no direct feedback required from the user.

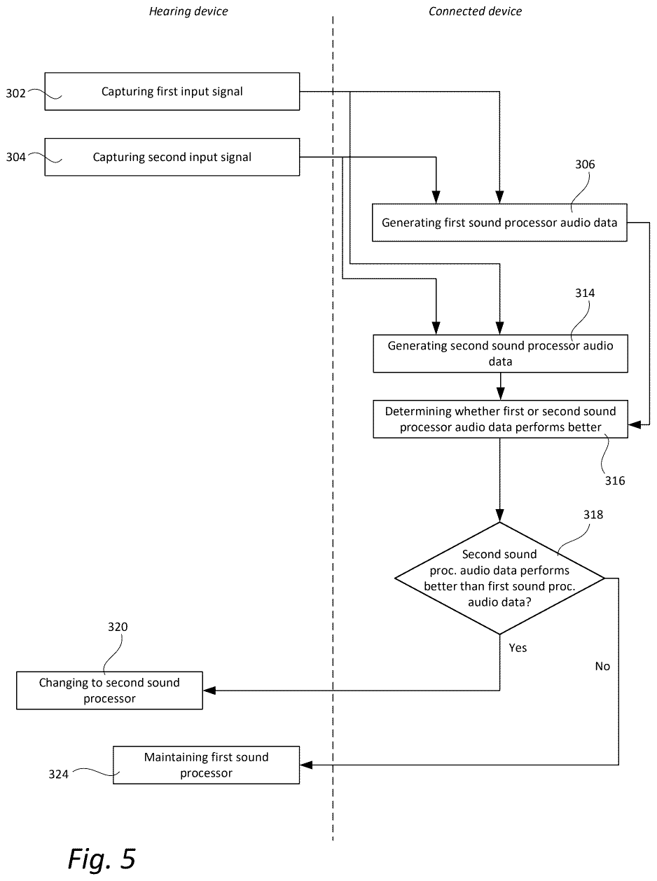

As described above, the different steps may all be performed in the hearing device 102, but it is also possible to have some of the steps performed in the connected device. In FIG. 5, it is illustrated an example in which most of the data processing, which may also be referred to as signal processing, is shifted to the connected device. As illustrated, the steps of capturing 302 the first input signal and capturing 304 the second input signal are performed in the hearing device, and the first and input signal are transferred to the connected device such that the first sound processor audio data is generated 306 by the first sound processor, and also that the second sound processor audio data is generated 314 by the second processor. Once the first and second sound processor audio data is generated, the step of determining 316 whether the first or second sound processor audio data performs better based on the comparison 318 of the objective measure can be performed in the connected device. In case the second sound processor audio data performs better, a signal indicating that the hearing device setting is to be changed to comprise the second sound processor, as well as that the second sound processor audio data may be transmitted from the connected device to the hearing device. On the other hand, in case the first sound processor audio data performs better, a signal indicating that the hearing device setting comprising the first sound processor is to be maintained can be transmitted from the connected device to the hearing device.

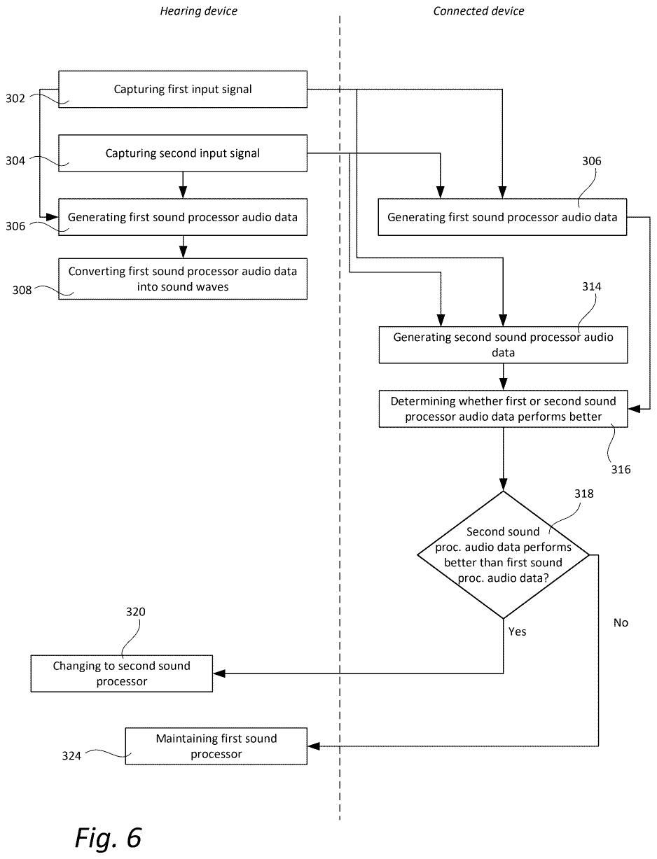

FIG. 6 illustrates another example of how the different steps may be split between the hearing device and the connected device. In line with the example illustrated in FIG. 5, the steps of capturing 302 the first input signal and capturing 304 the second input signal are performed in the hearing device. However, unlike the example illustrated in FIG. 5, the step of generating 306 first sound processor audio data may be performed in both the hearing device and the connected device. By having this step performed in the hearing device, the first sound processor audio data may be used for converting 308 the first sound processor audio data into sound waves. Put differently, audio information is presented to the user. By generating 306 the first sound processor audio data in the connected device as well, the process of assessing the hearing device current setting may be made independently from the process of producing sound waves via the speaker, sometimes referred to as transducer. This may be beneficial in that the two processes may be optimized independently. Further, by not having the two processes using the same hardware components may reduce a risk of interference, which could potentially result in delays or other unwanted effects for the user.

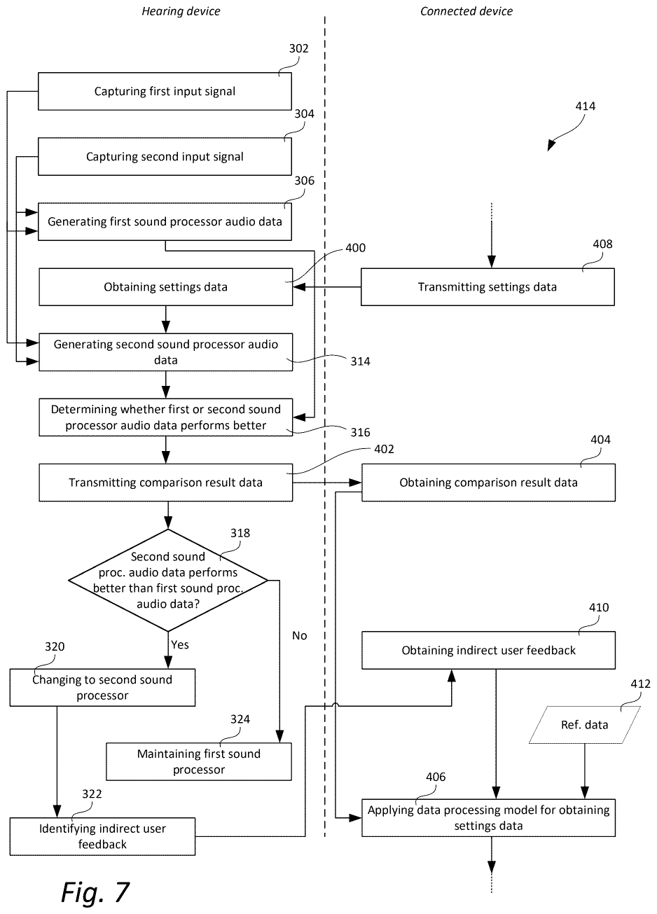

FIG. 7 illustrates yet another example on how the method of assessing the hearing device setting may be split between the hearing device 102 and the connected device. In the example illustrated in FIG. 7, the following steps can be performed in the hearing device:

capturing 302 the first input signal, capturing 304 the second input signal, generating 306 first sound processor audio data, generating 314 second sound processor audio data, determining 316 whether the first sound processor audio data or the second sound processor audio data performs better based on the comparison 318, changing 320 the hearing device setting to comprise the second sound processor, if the second sound processor audio data performs better, else maintaining 324 the current hearing device setting. Further, the step identifying 324 the indirect user feedback, such as removal of the hearing device, may also be performed in the hearing device.

In addition, the method may further comprise obtaining 400 settings data pertaining to the second sound processor from the connected device, and transmitting 402 comparison result data, pertaining to an outcome of the step of determining 316 whether the first sound processor audio data or the second sound processor audio data performs better based on a comparison of an objective measure, to the connected device.

An interrelated method 414 performed in the connected device can comprise obtaining 404 the comparison result data pertaining to the outcome of a step of determining 316 whether the first sound processor audio data or previous second sound processor audio data performs better based on the comparison of the objective measure from the hearing device 102, wherein the previous second processor audio data is generated by processing first and second input signals with a previous second sound processor, and the first sound processor audio data is generated by processing the first and second input signals with the first sound processor, wherein the first and second input signals are captured by a first and second microphone of the hearing device 102, respectively, applying 406 a data processing model, wherein the data processing model receives as inputs the previous second sound processor, the first sound processor and the comparison result data, and outputs the settings data pertaining to the second sound processor, and transmitting 408 the settings data from the connected device to the hearing device 102. The data processing model may be based on reference data 412 originating from a plurality of different users. By using this reference data, it is made possible to learn from other users having similar physical properties, thereby making it possible to more efficiently find a hearing device setting adjusted in line with the physical properties of the user quicker and more efficiently in terms of computational power. Further, the method 414 may also comprise obtaining 410 the indirect user feedback from the hearing device such that this can be fed into the data processing model, thereby providing for this information is also taken into account. For instance, in case the hearing device setting is changed to comprise the second sound processor, and the change in the hearing device setting causes the user to move the hearing device, this information may be fed to the connected device such that when determining the settings data pertaining to the second sound processor, this can be taken into account. In this way, in case a change of the hearing device setting from the first sound processor is not appreciated by the user, indicated by that the user is trying to change the position of the hearing device in the ear, this can be picked up and be taken into account such that the hearing device setting is changed again to a sound processor that is more appreciated by the user.

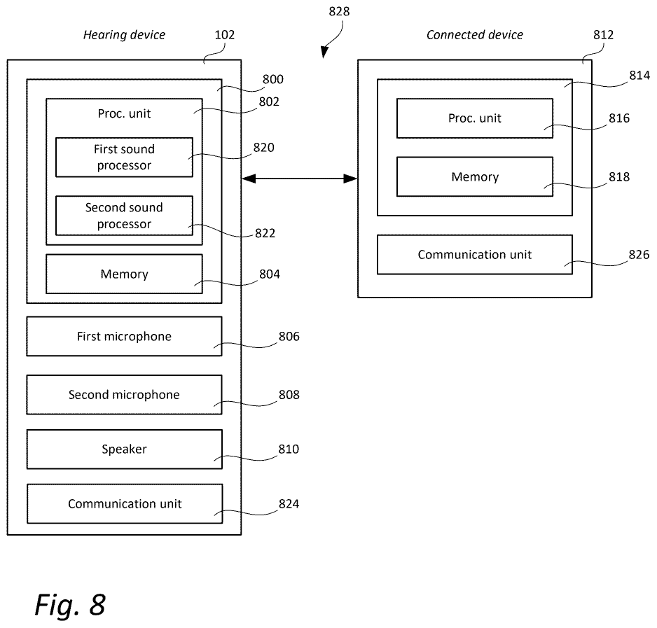

FIG. 8 generally illustrates an arrangement 828 comprising the hearing device 102 and the connected device 812. As illustrated, the hearing device 102 may comprise a control circuitry 800, which in turn may comprise a processing unit 802 and a memory 804. The hearing device 102 may further comprise the first and the second microphone 806, 808, wherein the second microphone is optional, as well as the speaker 810. The connected device 812, which may be a mobile phone, a smart watch or any other device having data processing capability and that can be communicatively connected to the hearing device 102, may comprise a control circuitry 814 comprising a processing unit 816 and a memory 818.

As illustrated, the processing unit 802 of the hearing device 102 can comprise the first and the second sound processor 820, 822 such that the first and second sound processor audio data can be generated. As described above, these may also be provided in the processing unit 816 of the connected device 812 or in both the processing unit 802 of the hearing device 102 and the processing unit 816 of the connected device 812.

To provide for that data can be exchanged between the hearing device 102 and the connected device 812, the hearing device 102 may be provided with a communication unit 824 and the connected device 812 may also be provided with a communication unit 826.

Although particular features have been shown and described, it will be understood that they are not intended to limit the claimed invention, and it will be made obvious to those skilled in the art that various changes and modifications may be made without departing from the scope of the claimed invention. The specification and drawings are, accordingly, to be regarded in an illustrative rather than restrictive sense. The claimed invention is intended to cover all alternatives, modifications, and equivalents.

### ITEMS

1. A computer-implemented method (300) for continuously assessing a hearing device setting used in a hearing device (102), said hearing device (102) comprising a housing (104), a control circuitry (800) comprising a processing unit (802) and a memory (804), a first and a second microphone (806, 808), and a speaker (810), wherein the hearing device setting comprises a first sound processor, said method (300) comprising
capturing (302) a first input signal using the first microphone (806),
generating (306) first sound processor audio data by processing the first input signal using the first sound processor (820),
generating (314) second sound processor audio data by processing the first input signal using a second sound processor (822), and
determining (316) whether the first sound processor audio data or the second sound processor audio data performs better based on a comparison of an objective measure.
2. The method according to item 1, wherein
in case the second sound processor audio data is determined to perform better than the first sound processor audio data based on the comparison (318) of the objective measure,
   changing (320) the hearing device setting to comprise the second sound processor,
else,
   maintaining (324) that the hearing device setting comprises the first sound processor.
3. The method according to item 1 or 2, wherein the hearing device further comprises a second microphone, and the method further comprises
capturing (304) a second input signal using the second microphone (808);
generating (306) first sound processor audio data by processing the first and second input signals using the first sound processor (820); and
generating (314) second sound processor audio data by processing the first and second input signals using a second sound processor (822).
4. The method according to any of the preceding items, wherein the first sound processor comprises a first neural network, a first regression model, and/or a first digital signal filter, and wherein and the second sound processor comprises a second neural network, a second regression model, and/or a second digital signal filter.
5. The method according to any of the preceding items, wherein the step of determining (316) whether the first sound processor audio data or the second sound processor audio data performs better based on the comparison of the objective measure comprises the sub-steps of
determining (326) signal power for the first sound processor audio data,
determining (328) signal power for the second sound processor audio data,
comparing (330) the signal power for the second sound processor audio data with the signal power for the first sound processor audio data, and
if the signal power for the second sound processor audio data is greater than the signal power for the first sound processor audio data, determine that the second sound processor audio data performs better than the first sound processor audio data.
6. The method according to item 4, wherein the step of determining (326) the signal power for the first sound processor audio data comprises determining the signal power in frequency bands linked to speech, and wherein the step of determining (328) the signal power for the second sound processor audio data comprises determining the signal power in frequency bands linked to speech.
7. The method according to any of the preceding items, wherein the objective measure is a speech intelligibility measure, and the step of determining whether the first sound processor audio data or the second sound processor audio data performs better based on the comparison of the objective measure comprises the sub-steps of
determining a first speech intelligibility measurement for the first sound processor audio data,
determining (328) a second speech intelligibility measurement for the second sound processor audio data,
comparing (330) the first and second speech intelligibility measures for the second sound processor audio data with the signal power for the first sound processor audio data, and
if the second speech intelligibility measurement is greater than the first speech intelligibility measurement, determine that the second sound processor audio data performs better than the first sound processor audio data.
8. The method according to any of the preceding items, wherein the first and second sound processors are beamformers.
9. The method according to any one of the preceding items, further comprising
converting (308) the first sound processor audio data into sound waves by using the speaker (810) at a first time point,
wherein the steps of generating (314) second sound processor audio data by processing the first and second input signals using the second sound processor (822), and determining (316) whether the first sound processor audio data or the second sound processor audio data performs better based on a comparison of an objective measure is performed at a second time point subsequent to the first time point.
10. The method according to any one of the preceding items, further comprising
monitoring (310) a utilization rate of the processing unit (802),
in case the utilization rate is below a threshold,
   performing the steps of generating (314) second sound processor audio data by processing the first input signal using the second sound processor (822), and determining (316) whether the first sound processor audio data or the second sound processor audio data performs better based on a comparison of an objective measure.
11. The method according to any one of the preceding items, wherein the hearing device (102) further comprises a communication unit (824) communicatively connected to a connected device (812), said method further comprising
obtaining (400) settings data pertaining to the alternative hearing device setting from the connected device (812), and
transmitting (402) comparison result data, pertaining to an outcome of the step of determining (316) whether the first sound processor audio data or the second sound processor audio data performs better based on a comparison of an objective measure, to the connected device (812).
12. The method according to any one of the items 3 to 11, wherein the hearing device (102) further comprises a communication unit (824) communicatively connected to a connected device (812),
wherein the steps of capturing (302) the first input signal and capturing (304) the second input signal are performed in the hearing device (102),
wherein the steps of generating (314) the second sound processor audio data and determining (316) whether the first sound processor audio data or the second audio data sound processor performs better based on a comparison of an objective measure are performed in the connected device (812),
wherein the step of changing (320) the hearing device setting to comprise the second sound processor is performed in the hearing device (102).
13. The method according to item 12, wherein the step of generating (306) the first sound processor audio data by processing the first and second input signals using a first sound processor (820) is performed both in the hearing device (102) and in the connected device (812).
14. The method according to any one of the items 2 to 13, wherein subsequent to the step of changing the hearing device setting to comprise the second sound processor, the method further comprises identifying (322) indirect user feedback data.
15. A method (414) for determining a hearing device setting for a hearing device (102) by using a connected device (812) communicatively connected to the hearing device (102), said method comprising
obtaining (404) comparison result data pertaining to an outcome of a step of determining (316) whether first sound processor audio data or previous second sound processor audio data performs better based on a comparison of an objective measure from the hearing device (102), wherein the previous second processor audio data is generated by processing first and second input signals with a previous hearing device setting, and the first sound processor audio data is generated by processing the first and second input signals with a current hearing device setting, wherein the first and second input signals are captured by a first and second microphone (806, 808) of the hearing device (102), respectively,
applying (406) a data processing model, wherein the data processing model receives as inputs the previous hearing device setting, the current hearing device setting and the comparison result data, and outputs settings data pertaining to an alternative hearing device setting, and
transmitting (408) the settings data from the connected device (812) to the hearing device (102).
16. The method according to item 15, wherein the data processing model is based on reference data (412) originating from a plurality of different users.
17. An hearing system (828) comprising a hearing device (102) comprising a housing (104), a control circuitry (800) comprising a processing unit (802) and a memory (804), a first microphone (806), and a speaker (810), and a connected device (812) communicatively connected to the hearing device (102), wherein the arrangement is configured to:
capture a first input signal using the first microphone (806),
generate first sound processor audio data by processing the first input signal,
generate second processor audio data by processing the first input signal, and
determine whether the first sound processor audio data or the second sound processor audio data performs better based on a comparison of an objective measure.
18. A hearing device (102) comprising a housing (104), a control circuitry (800) comprising a processing unit (802) and a memory (804), a first microphone (806), and a speaker (810), wherein said control circuitry is configured to:
capture a first input signal using the first microphone (806),
generate first sound processor audio data by processing the first input signal using a first sound processor (820),
generate second sound processor audio data by processing the first input signal using a second sound processor (822), and
determine whether the first sound processor audio data or the second sound processor audio data performs better based on a comparison of an objective measure.
19. A connected device comprising a control circuitry comprising a processing unit and a memory, wherein the connected device is communicatively connected to a hearing device, wherein the control circuitry is configured to:
obtain comparison result data pertaining to an outcome of a step of determining whether first sound processor audio data or previous second sound processor audio data performs better based on a comparison of an objective measure from the hearing device,
wherein the previous second processor audio data is generated by processing first and second input signals with a previous alternative hearing device setting, and the first sound processor audio data is generated by processing the first and second input signals with a current hearing device setting, wherein the first and second input signals are captured by a first and second microphone of the hearing device, respectively, apply a data processing model,
wherein the data processing model receives as inputs the previous alternative hearing device setting, the current hearing device setting and the comparison result data, and outputs settings data pertaining to an alternative hearing device setting, and transmit the settings data from the connected device to the hearing device.
20. A computer program product, loadable in a memory of a control circuitry of a hearing device, comprising instructions suitable for performing the steps of the method according to any one of the items 1 to 14.
21. A computer program product, loadable in a memory of a control circuitry of a connected device, comprising instructions suitable for performing the steps of the method according to any one of the items 15 to 16.

### LIST OF REFERENCES

100—ear
102—hearing device/hearing aid/hearing instrument
104—housing
800—control circuitry in hearing device
802—processing unit in hearing device
804—memory in hearing device
806—first microphone
808—second microphone
810—speaker
812—connected device
814—control circuitry in connected device
816—processing unit in connected device
818—memory in connected device
820—first sound processor
822—second sound processor
824—communication unit in hearing device
826—communication unit in connected device
828—arrangement

1. A hearing system comprising:
a hearing device comprising a housing, a memory, a first microphone, and a speaker; and
a connected device communicatively connected to the hearing device;
wherein the hearing system is configured to:
obtain a first input signal using the first microphone of the hearing device,
generate first sound processor audio data by processing the first input signal,
generate second processor audio data by processing the first input signal, and
determine whether the first sound processor audio data or the second sound processor audio data performs better based on a comparison of an objective measure.

2. The hearing system according to claim 1, wherein the hearing system comprises a first sound processor and a second sound processor;
wherein the hearing system is configured to change a setting to comprise the second sound processor if the second sound processor audio data is determined to perform better than the first sound processor audio data based on the comparison of the objective measure; and
wherein the hearing system is configured to maintain the setting to comprise the first sound processor If the first sound processor audio data is determined to perform better than the second sound processor audio data based on the comparison of the objective measure.

3. The hearing system according to claim 2, wherein the hearing system is configured to identify indirect user feedback data after the setting is changed to comprise the second sound processor.

4. The hearing system according to claim 1, wherein the hearing device further comprises a second microphone, and wherein the hearing system is configured to obtain a second input signal using the second microphone of the hearing device;
wherein the hearing system is configured to generate the first sound processor audio data by processing the first and second input signals; and
wherein the hearing system is configured to generate the second sound processor audio data by processing the first and second input signals.

5. The hearing system according to claim 1, wherein the hearing system is configured to determine a hearing device setting, the hearing device setting comprising a first sound processor or a second sound processor;
wherein the first sound processor comprises a first neural network, a first regression model, and/or a first digital signal filter; and
wherein the second sound processor comprises a second neural network, a second regression model, and/or a second digital signal filter.

6. The hearing system according to claim 1, wherein the hearing system is configured to determine whether the first sound processor audio data or the second sound processor audio data performs better based on the comparison of the objective measure by:
determining signal power for the first sound processor audio data,
determining signal power for the second sound processor audio data,
comparing the signal power for the second sound processor audio data with the signal power for the first sound processor audio data, and
determining that the second sound processor audio data performs better than the first sound processor audio data if the signal power for the second sound processor audio data is greater than the signal power for the first sound processor audio data.

7. The hearing system according to claim 6, wherein the signal power for the first sound processor audio data is in frequency bands linked to speech, and wherein the signal power for the second sound processor audio data is in the frequency bands linked to the speech.

8. The hearing system according to claim 1, wherein the hearing system is configured to convert the first sound processor audio data into sound waves by using the speaker at a first time point; and
wherein the hearing system is configured to generate the second sound processor audio data, and to determine whether the first sound processor audio data or the second sound processor audio data performs better based on the comparison of the objective measure, at a second time point subsequent to the first time point.

9. The hearing system according to claim 1, wherein the hearing system is configured to monitor a utilization rate of a processing unit of the hearing device; and
wherein the hearing system is configured to generate the second sound processor audio data, and to determine whether the first sound processor audio data or the second sound processor audio data performs better based on the comparison of the objective measure, after the utilization rate is determined to be below a threshold.

10. The hearing system according to claim 1, wherein the hearing device further comprises a communication unit communicatively connected to a connected device:
wherein the hearing device is configured to transmit comparison result data to the connected device, the comparison result data pertaining to an outcome from the act of determining whether the first sound processor audio data or the second sound processor audio data performs better based on the comparison of the objective measure.

11. A method for continuously assessing a hearing device setting used in a hearing device, the hearing device comprising a housing, a memory, a first microphone, and a speaker, wherein the hearing device setting comprises a first sound processor, the method comprising:
obtaining a first input signal using the first microphone of the hearing device,
generating first sound processor audio data by processing the first input signal using the first sound processor,
generating second sound processor audio data by processing the first input signal using a second sound processor, and
determining whether the first sound processor audio data or the second sound processor audio data performs better based on a comparison of an objective measure.

12. The method according to claim 11, wherein:
If the second sound processor audio data is determined to perform better than the first sound processor audio data based on the comparison of the objective measure, changing the hearing device setting to comprise the second sound processor; and
If the first sound processor audio data is determined to perform better than the second sound processor audio data based on the comparison of the objective measure, maintaining the hearing device setting to comprise the first sound processor.

13. The method according to claim 12, wherein subsequent to the act of changing the hearing device setting to comprise the second sound processor, the method further comprises identifying indirect user feedback data.

14. The method according to claim 11, wherein the hearing device further comprises a second microphone, and wherein the method further comprises capturing a second input signal using the second microphone of the hearing device;
wherein the first sound processor audio data is generated by processing the first and second input signals using the first sound processor; and
wherein the second sound processor audio data is generated by processing the first and second input signals using the second sound processor.

15. The method according to claim 11, wherein the first sound processor comprises a first neural network, a first regression model, and/or a first digital signal filter; and
wherein the second sound processor comprises a second neural network, a second regression model, and/or a second digital signal filter.

16. The method according to claim 11, wherein the act of determining whether the first sound processor audio data or the second sound processor audio data performs better based on the comparison of the objective measure comprises:
determining signal power for the first sound processor audio data,
determining signal power for the second sound processor audio data,
comparing the signal power for the second sound processor audio data with the signal power for the first sound processor audio data, and
if the signal power for the second sound processor audio data is greater than the signal power for the first sound processor audio data, determining that the second sound processor audio data performs better than the first sound processor audio data.

17. The method according to claim 16, wherein the act of determining the signal power for the first sound processor audio data comprises determining the signal power for the first sound processor audio data in frequency bands linked to speech, and wherein the act of determining the signal power for the second sound processor audio data comprises determining the signal power for the second sound processor audio data in the frequency bands linked to the speech.

18. The method according to claim 11, further comprising
converting the first sound processor audio data into sound waves by using the speaker at a first time point,
wherein the act of generating the second sound processor audio data by processing the first input signal, and the act of determining whether the first sound processor audio data or the second sound processor audio data performs better based on the comparison of the objective measure, are performed at a second time point subsequent to the first time point.

19. The method according to claim 11, further comprising monitoring a utilization rate of a processing unit of the hearing device, the processing unit comprising the first sound processor;
wherein the act of generating the second sound processor audio data by processing the first input signal using the second sound processor, and the act of determining whether the first sound processor audio data or the second sound processor audio data performs better based on the comparison of the objective measure, are performed after the utilization rate is determined to be below a threshold.

20. The method according to claim 11, wherein the hearing device further comprises a communication unit communicatively connected to a connected device; and
wherein the method further comprises transmitting comparison result data to the connected device, the comparison result data pertaining to an outcome from the act of determining whether the first sound processor audio data or the second sound processor audio data performs better based on the comparison of the objective measure.

21. The method according to claim 11, wherein the hearing device further comprises a communication unit communicatively connected to a connected device;
wherein the act of obtaining the first input signal is performed by the hearing device;
wherein the act of generating the second sound processor audio data, and the act of determining whether the first sound processor audio data or the second audio data sound processor performs better based on the comparison of the objective measure, are performed by the connected device; and
wherein the method further comprises changing the hearing device setting to comprise the second sound processor, and wherein the act of changing the hearing device setting is performed by the hearing device.

22. A method of determining a hearing device setting for a hearing device performed by a connected device communicatively connected to the hearing device, the method comprising:
obtaining comparison result data pertaining to an outcome of determining whether first sound processor audio data or previous second sound processor audio data performs better based on a comparison of an objective measure from the hearing device, wherein the previous second processor audio data is generated by processing a first input signal with a previous second sound processor, and the first sound processor audio data is generated by processing the first input signal with a first sound processor, wherein the first input signal is obtained using a first microphone of the hearing device;
applying a data processing model, wherein the data processing model is configured to receive information about the previous second sound processor, information about the first sound processor, and the comparison result data, and to output settings data; and
transmitting the settings data from the connected device to the hearing device.

23. A hearing device comprising:
a housing;
a control circuitry comprising a processing unit in the housing;
a memory in the housing;
a first microphone coupled with the control circuitry; and
a speaker coupled with the control circuitry;
wherein the control circuitry is configured to:
obtain a first input signal using the first microphone of the hearing device,
generate first sound processor audio data by processing the first input signal,
generate second sound processor audio data by processing the first input signal, and
determine whether the first sound processor audio data or the second sound processor audio data performs better based on a comparison of an objective measure.

24. A hearing system comprising the hearing device of claim 23 and a connected device communicatively connected to the hearing device.
